(19) United States
(12) Patent Application Publication
(10) Pub. No.: US 2025/0087957 A1
(43) Pub. Date: Mar. 13, 2025

(54) OPTICAL COMPONENT, LENS HOLDING STRUCTURE, AND OPTICAL COMMUNICATION MODULE

(71) Applicant: NEC Corporation, Tokyo (JP)

(72) Inventor: Taro Kaneko, Tokyo (JP)

(73) Assignee: NEC Corporation, Tokyo (JP)

(21) Appl. No.: 18/813,212

(22) Filed: Aug. 23, 2024

(30) Foreign Application Priority Data
Sep. 8, 2023 (JP) 2023-146259

(51) Int. Cl. H01S 3/00

(52) U.S. Cl. CPC H01S 3/0071

(57) ABSTRACT

It is aimed to provide an optical component, a lens holding structure, and an optical communication module that can realize miniaturization while coping with optical axis deviation. An optical component includes a holder and a lens. The lens having a first central axis along a first direction. The holder having a second central axis along the first direction, having a principal surface perpendicular to the first direction, and on which the lens is mounted in such a manner that the first central axis is eccentric from the second central axis.

### INCORPORATION BY REFERENCE

This application is based upon and claims the benefit of priority from Japanese patent application No. 2023-146259, filed on Sep. 8, 2023, the disclosure of which is incorporated herein in its entirety by reference.

### TECHNICAL FIELD

The present disclosure relates to an optical component, a lens holding structure and an optical communication module.

### BACKGROUND ART

An optical transceiver used in optical communication includes optical components and electronic components that are mounted on a package. In the optical transceiver, the package is provided with a snout for inputting and outputting light. A lens component is fixed to the rear stage of the snout. an optical signal output from the optical transceiver passes through the snout, then passes through the lens component, and is output to an external optical fiber.

The lens component includes a lens and a metal tube on which the lens is mounted. When fixing the lens component to the snout, a portion of the snout through which light passes is aligned with the optical axis of the lens, and the metal tube is welded to the snout, for example.

For example, in Patent Literature 1, as an example of an optical communication module capable of preventing optical axis deviation, an optical element module capable of simultaneously performing optical axis adjustment and light intensity adjustment when polarization-combining two modulated lights is proposed.

### CITATION LIST

[Patent Literature 1] Japan Unexamined Patent application Publication No. 2014-199364

### SUMMARY

However, the optical axis may deviate from the center of the snout due to manufacturing errors or the like. When a lens component is attached to the snout in accordance with the optical axis deviation, the lens component is attached eccentrically to the snout. Even in this case, to prevent the lens component from protruding from the snout, it is necessary to increase the size of the snout. As a result, there is a problem that miniaturization of the optical communication module is restricted by the size of the snout.

In an example aspect of the present disclosure, an optical component including: a lens having a first central axis along a first direction; and a holder having a second central axis along the first direction, having a principal surface perpendicular to the first direction, and on which the lens is mounted in such a manner that the first central axis is eccentric from the second central axis.

In an example aspect of the present disclosure, a lens holding structure including: a snout provided with a window through which light emitted from a light source passes and provided on a light emission side of a package accommodating the light source; and an optical component attached to the snout, in which the optical component includes: a lens having a first central axis along a first direction on which the light passing through the window of the snout is incident; and a holder having a second central axis along the first direction, having a principal surface perpendicular to the first direction, and on which the lens is mounted in such a manner that the first central axis is eccentric from the second central axis.

In an example aspect of the present disclosure, an optical communication module including: a light source configured to emit light; a package including the light source and an optical system for guiding the light emitted from the light source, the light being emitted from an end of the package; a snout provided with a window through which the light emitted from the light source passes and provided on a light emission side of the package; and an optical component provided to the snout, in which the optical component includes: a lens having a first central axis along a first direction on which the light passing through the window of the snout is incident; and a holder having a second central axis along the first direction, having a principal surface perpendicular to the first direction, and on which the lens is mounted in such a manner that the first central axis is eccentric from the second central axis.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a side sectional view schematically showing a configuration of a general optical communication module;

FIG. 2 is a front view showing an example of an ideal positional relationship between a snout and a lens assembly;

FIG. 3 is a front view showing an example of a positional relationship between the snout and the lens assembly when an optical axis of laser light deviates;

FIG. 4 is a side sectional view schematically showing a configuration of an optical communication module according to an example embodiment;

FIG. 5 is a front view schematically showing a configuration of a snout;

FIG. 6 is a front view schematically showing a configuration of a lens assembly;

FIG. 7 is a front view showing an example of a configuration of a lens holding structure when the snout and the lens assembly are in an ideal positional relationship; and

FIG. 8 is a front view showing a configuration example of the lens holding structure when an optical axis of laser light deviates.

### EXAMPLE EMBODIMENT

Example Embodiments of the present disclosure will be described below with reference to the drawings. In each of the drawings, the same elements are denoted by the same reference numerals, and redundant explanations will be omitted if necessary.

Hereinafter, the term “an example embodiment” can be applied to any of the example embodiments described below or to a combination of two or more example embodiments. Application of the term “an example embodiment” is not limited to the specific example embodiment.

First, a configuration of a general optical communication module will be described as a premise for understanding an optical communication module according to the present disclosure.

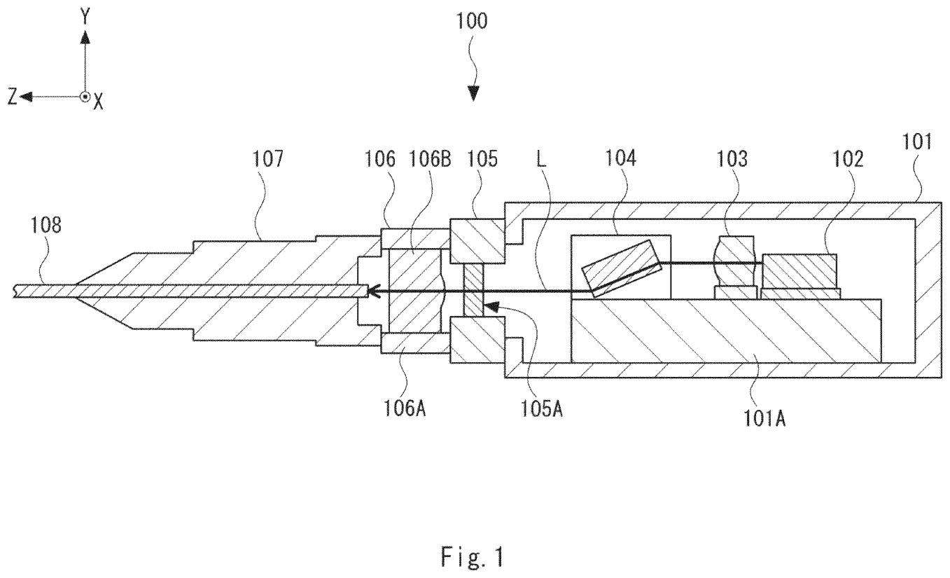

FIG. 1 is a side sectional view schematically showing a configuration of a general optical communication module 100. Hereinafter, in the plane of FIG. 1, an upward vertical direction is defined as a Y direction. In FIG. 1, a horizontal direction toward the left is defined as a Z direction. In FIG. 1, a normal direction toward the front is defined as an X direction. The Z direction is also referred to as a first direction.

A general optical communication module 100 includes a package 101, a light source element 102, a lens 103, an isolator 104, a snout 105, a lens assembly 106, and a fiber support 107.

The package 101 is configured as a member capable of accommodating various optical components and electrical components therein. A pedestal 101A is provided in the package 101. The light source element 102, the lens 103, and the isolator 104 are mounted on the pedestal 101A.

The light source element 102 is a light emitting element such as a semiconductor laser, for example, and emits laser light L. The lens 103 guides the laser light L to an incident plane of the isolator 104. The isolator 104 prevents the laser light L from returning to the lens 103 after passing through the isolator 104.

The snout 105 is provided at an end of the package 101 from which the laser light L emits, that is, at a +Z-side end of the package 101 in FIG. 1. A window 105A for guiding the laser light L is provided at the center of the snout 105.

The lens assembly 106 is provided at an emission end of the snout 105, that is, at a +Z-side end of the snout 105 in FIG. 1. The snout 105 and the lens assembly 106 are joined by welding, for example.

The lens assembly 106 includes a holder 106A and a lens 106B. The lens 106B is mounted on the holder 106A to be concentric with the holder 106A whose principal plane is an X-Y plane. The laser light L that has passed through the isolator 104 passes through the window 105A provided in the center of the snout 105, and is incident on the lens 106B of the lens assembly 106.

The fiber support 107 is provided at an emission end of the lens assembly 106, that is, at an +Z-side end of the lens assembly 106 in FIG. 1. An optical fiber 108 is inserted into the fiber support 107. The laser light L emitted from the lens 106B is incident on an end face of the optical fiber 108. The laser light L incident on the end face of the optical fiber 108 propagates through the optical fiber 108 and is transmitted to the outside of the general optical communication module 100.

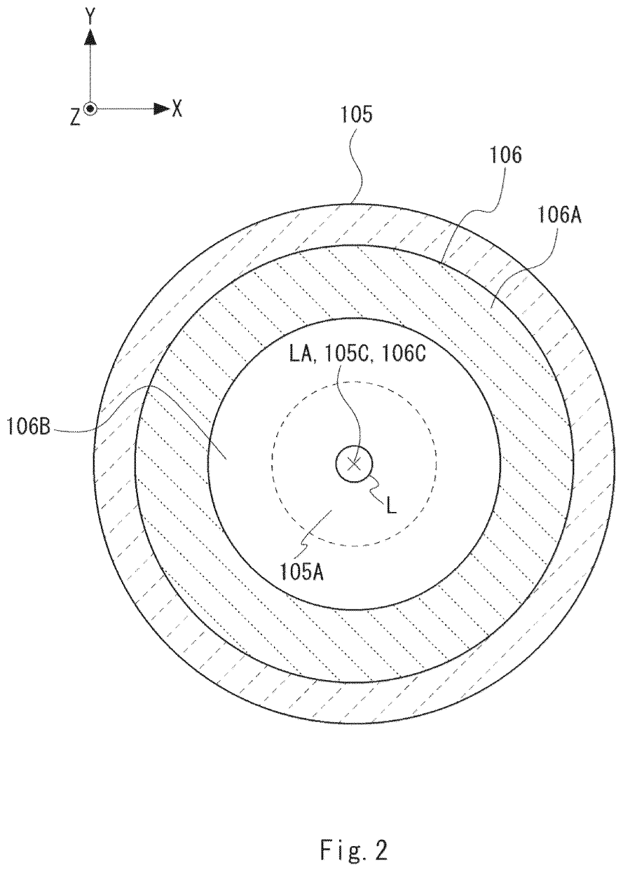

A positional relationship between the snout 105 and the lens assembly 106 will be described. FIG. 2 is a front view showing an example of an ideal positional relationship between the snout 105 and the lens assembly 106. In FIG. 2, the snout 105 and the holder 106A are indicated by a broken line pattern for convenience of explanation. Hereinafter, in the front view, an upward vertical direction on the plane is defined as the Y direction. A horizontal direction toward the right on the plane is defined as the X direction. A normal direction toward the front of the plane is defined as the Z direction. As described above, the lens 106B is mounted on the holder 106A to be concentric with the holder 106A having a cylindrical shape.

The lens assembly 106 is aligned in such a manner that an optical axis LA of the laser light L passing through the window 105A of the snout 105 coincides with a central axis 106C of the lens 106B. Then, by welding the lens assembly 106 to the snout 105, the positional relationship between the lens assembly 106 and the snout 105 is fixed.

FIG. 2 shows an ideal example in which the optical axis LA of the laser light L coincides with a central axis 105C of the window 105A. In this case, the lens assembly 106 is arranged to be concentric with the snout 105 by aligning the optical axis LA of the laser light L with the central axis 106C of the lens 106B.

However, although it is desirable that the optical axis LA of the laser light L passes through the central axis 105C of the window 105A, a position of the optical axis LA of the laser light L may deviate due to manufacturing errors occurring when components such as the light source element 102, the lens 103, and the isolator 104 are mounted in the package 101.

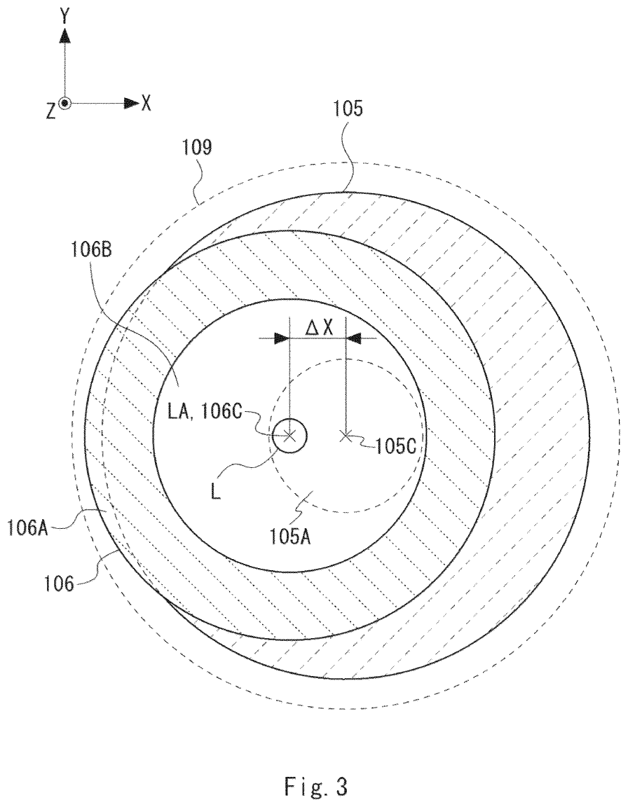

FIG. 3 is a front view showing an example of the positional relationship between the snout 105 and the lens assembly 106 when the optical axis LA of the laser light L deviates. In FIG. 3, the snout 105 and the holder 106A are indicated by a broken line pattern for convenience of explanation. In this example, compared with FIG. 2, the optical axis LA of the laser light L deviates from the central axis 105C of the window 105A by ΔX in the −X direction. In this case, to align the central axis 106C of the lens 106B with the optical axis LA of the laser light L, the lens assembly 106 is shifted by ΔX in the −X direction and joined to the snout 105. Therefore, the central axis 106C of the lens 106B deviates from the central axis 105C of the window 105A by ΔX in the −X direction. As a result, depending on a size of the snout 105, the holder 106A may protrude from the snout 105 as shown in FIG. 3.

To prevent the holder 106A from protruding from the snout 105, it is necessary to increase the size of the snout 105, for example, as shown by an outline 109 in FIG. 3. However, if the size of the snout 105 is increased, an overall size of the general optical communication module 100 becomes large, which hinders miniaturization of the general optical communication module 100.

In particular, when the size of the snout 105 is larger than a size of the package 101, the miniaturization of the general optical communication module 100 is directly restricted by the snout 105.

In the following, an optical communication module according to the present disclosure that can solve a problem in which miniaturization is restricted due to optical axis deviation will be described.

### FIRST EXAMPLE EMBODIMENT

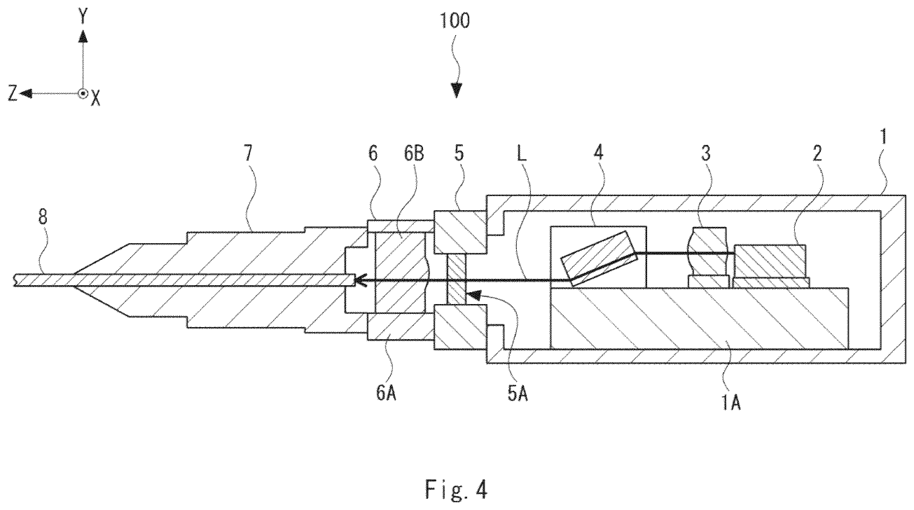

An optical communication module 10 according to a first example embodiment will be described. FIG. 4 is a side sectional view schematically showing a configuration of the optical communication module 10 according to an example embodiment. The optical communication module 10 includes a package 1, a light source element 2, a lens 3, an isolator 4, a snout 5, a lens assembly 6, and a fiber support 7.

The package 1, the light source element 2, the lens 3, the isolator 4, and the fiber support 7 correspond to the package 101, the light source element 102, the lens 103, the isolator 104, and the fiber support 107 of the general optical communication module 100 described above, respectively.

The package 1 is configured as a member capable of accommodating various optical components and electrical components therein. FIG. 4 shows an example in which the light source element 2, the lens 3, and the isolator 4 are mounted on a pedestal 1A in the package 1.

The light source element 2 is a light emitting element such as a semiconductor laser, for example, and emits a laser light L. The lens 3 guides the laser light L to an incident plane of the isolator 4. The isolator 4 prevents the incident laser light L from returning to the lens 3 after passing through the isolator 4.

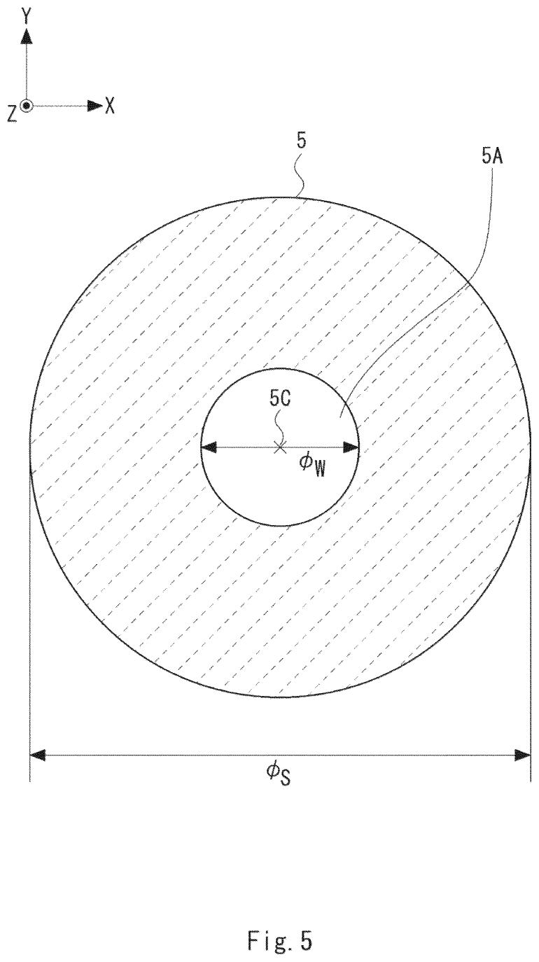

The snout 5 is provided at an end of the package 1 from which the laser light L emits, that is, at a +Z-side end of the package 1 in FIG. 4. FIG. 5 is a front view schematically showing a configuration of the snout 5. In FIG. 5, the snout 5 is indicated by a broken line pattern for convenience of explanation. A window 5A for guiding the laser light L is provided at the center of the snout 5. A diameter φs of the snout 5 is, for example, 3.2 mm. A diameter pw of the window 5A is, for example, 0.9 mm. A beam diameter of the laser light L is, for example, 0.1 to 0.3 mm. In this case, deviation of an optical axis LA is 0.3 to 0.4 mm.

A lens assembly 6, which is an optical component on which a laser light L is incident from the snout 5, is provided at an emission end of the snout 5, that is, at a +Z-side end of the snout 5 in FIG. 4. The snout 5 and the lens assembly 6 are joined by welding, for example. Hereinafter, the lens assembly 6 is also simply referred to as an optical component.

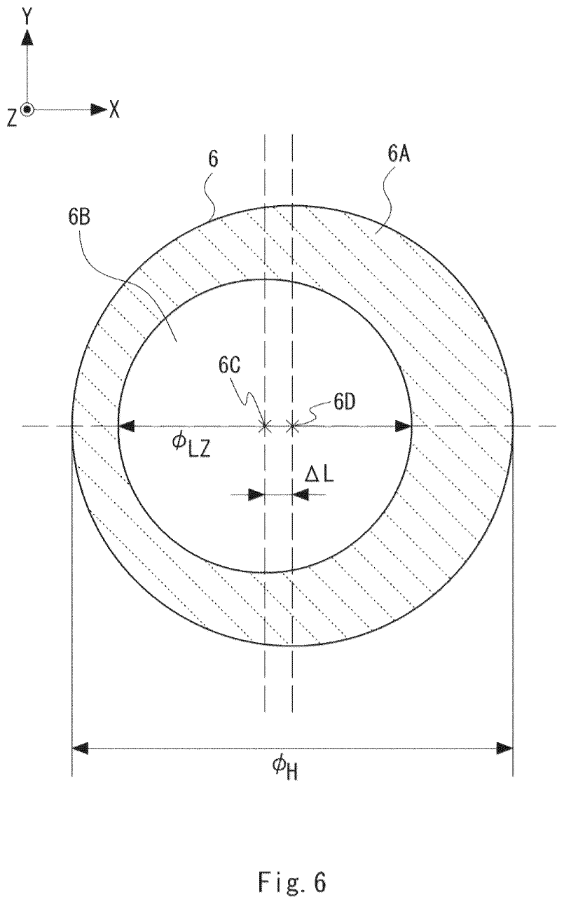

The lens assembly 6 includes a holder 6A and a lens 6B. FIG. 6 is a front view schematically showing a configuration of the lens assembly 6. In FIG. 6, the holder 6A is indicated by a broken line pattern for convenience of explanation. The lens 6B is mounted on the holder 6A to be eccentric by a distance ΔL with respect to the holder 6A having a cylindrical shape. That is, the central axis 6C of the lens 6B is deviates by ΔL from the central axis 6D of the holder 6A. Hereinafter, the central axis 6C is also referred to as a first central axis. The central axis 6D is also referred to as a second central axis. The laser light L that has passed through the isolator 4 passes through the window 5A provided in the center of the snout 5 and is incident on the lens 6B of the lens assembly 6.

The fiber support 7 is provided at an emission end of the lens assembly 6, that is, at a +Z-side end of the lens assembly 6 in FIG. 4. An optical fiber 8 is inserted into the fiber support 7. The laser light L emitted from the lens 6B is incident on an end face of the optical fiber 8. The laser light L incident on the end face of the optical fiber 8 propagates through the optical fiber 8 and is transmitted to the outside of the optical communication module 10.

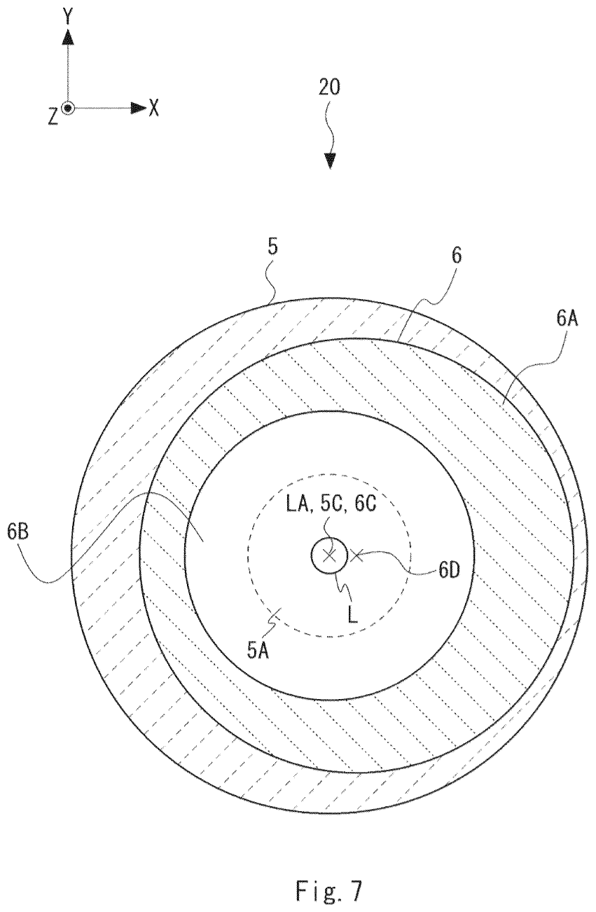

A positional relationship between the snout 5 and the lens assembly 6 will be described. In the present example embodiment, a structure composed of the snout 5 and the lens assembly 6 is referred to as a lens holding structure 20. FIG. 7 is a front view showing an example of a configuration of the lens holding structure when the snout 5 and the lens assembly 6 are in an ideal positional relationship. In FIG. 7, the snout 5 and the holder 6A are indicated by a broken line pattern for convenience of explanation. In the lens assembly 6, as described above, the lens 6B is mounted on the holder 6A to be eccentric with respect to the holder 6A having the cylindrical shape by the distance ΔL. A diameter φH of the holder 6A is, for example, 1.8 mm to 3.0 mm. A diameter φ_{LZ} of the lens 6B is, for example, 1.2 mm to 2 mm. ΔL is, for example, 0.2 mm.

In this example, the lens assembly 6 is aligned in such a manner that the optical axis LA of the laser light L passing through the central axis 5C of the window 5A of the snout 5 coincides with the central axis 6C of the lens 6B. Hereinafter, the central axis 5C is also referred to as a third central axis. Thereafter, by welding the lens assembly 6 to the snout 5, the positional relationship between the lens assembly 6 and the snout 5 is fixed.

However, as described above, although it is desirable that the optical axis LA of the laser light L passes through the central axis 5C of the window 5A, a position of the optical axis LA of the laser light L may be deviate due to manufacturing errors occurring when components such as the light source element 2, the lens 3, and the isolator 4 are mounted in the package 1.

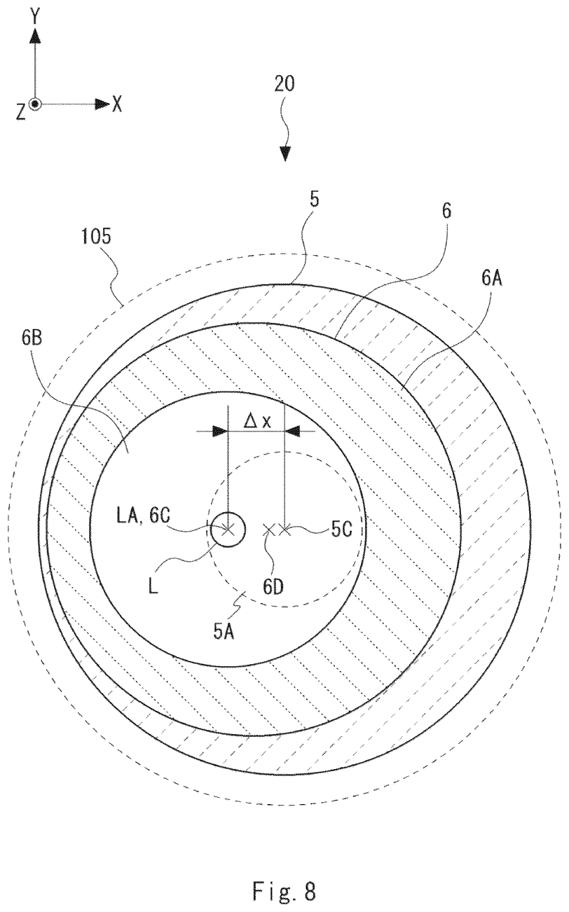

FIG. 8 is a front view showing a configuration example of the lens holding structure when the optical axis LA of the laser light L deviates. In FIG. 8, the snout 5 and the holder 6A are indicated by a broken line pattern for convenience of explanation. In this example, compared with FIG. 7, the optical axis LA of the laser light L deviates from the central axis 5C of the window 5A by ΔX in the −X direction. In this case, to align the central axis 6C of the lens 6B with the optical axis LA of the laser light L, the lens assembly 6 is shifted by ΔX in the −X direction and joined to the snout 5. Therefore, the central axis 6C of the lens 6B deviates from the central axis 5C of the window 5A by ΔX in the −X direction.

However, in the present configuration, it is possible to prevent the lens assembly 6 from protruding from the snout 5 by joining the lens assembly 6 to the snout 5 in such a manner that a thin portion of the holder 6A between the outer edge of the holder 6A and the lens 6B is in an eccentric direction of the laser light, that is, on the −X side.

Thus, an amount of positional deviation of the lens assembly 6 with respect to the snout 5 due to optical axis deviation can be suppressed. As a result, a size of the snout 5 can be reduced. As shown in FIG. 8, it can be seen that the size of the snout 5 can be reduced as compared with the snout 105 of the general optical communication module 100.

Here, the case where the optical axis LA of the laser light L deviates to the −X side has been described, but this is only an example. Even when the optical axis LA of the laser light L deviates arbitrary direction, it is possible to similarly prevent the lens assembly 6 from protruding from the snout 5 by joining the lens assembly 6 to the snout 5 in such a manner that the thin portion of the holder 6A is in the eccentric direction of the laser light.

In some applications, it is desirable to intentionally shift the central axis 6C of the lens 6B from the optical axis LA of the laser light L. Even in this case, the lens assembly 6 may be joined to the snout 5 in such a manner that the thin portion of the holder 6A may be arranged in the eccentric direction of the laser light or a direction close thereto.

As described above, according to the present configuration, the lens holding structure and the optical communication module can be miniaturized by suppressing the size of the snout.

### OTHER EMBODIMENTS

Although the present disclosure has been described with reference to the embodiments, the present disclosure is not limited to the above-described embodiments. Various changes can be made to the configuration and details of the present disclosure that would be understood by a person skilled in the art within the scope of the present disclosure. Each embodiment may then be combined with other embodiments as appropriate.

Each of the drawings is merely illustrative to illustrate one or more embodiments. Each drawing is not associated with only one particular embodiment, but may be associated with one or more other embodiments. As will be appreciated by those skilled in the art, various features or steps described with reference to any one drawing may be combined with features or steps shown in one or more other figures, for example, to create an embodiment not explicitly shown or described. Not all of the features or steps shown in any one figure are required to describe an exemplary embodiment, and some features or steps may be omitted. The order of the steps described in any one figure may be changed as appropriate.

Some or all of the above embodiments may also be described as noted below, but not limited to:

### (Supplementary Note 1)

An optical component including: a lens having a first central axis along a first direction; and a holder having a second central axis along the first direction, having a principal surface perpendicular to the first direction, and on which the lens is mounted in such a manner that the first central axis is eccentric from the second central axis.

### (Supplementary Note 2)

The optical component according to Supplementary note, in which the holder is provided with a window through which light emitted from a light source passes, and is attached to a snout provided on a light emission side of a package accommodating the light source, and the light passing through the window is incident on the lens.

### (Supplementary Note 3)

The optical component according to Supplementary note 2, in which, when an optical axis of the light deviates from a third central axis of the window, the holder is joined to the snout in such a manner that a thin portion between an outer edge of the holder and the lens is arranged in a direction in which the optical axis deviates from the third central axis.

### (Supplementary Note 4)

The optical component according to Supplementary note 3, in which the holder is joined to the snout in such a manner that the first central axis of the lens is aligned with the optical axis.

### (Supplementary Note 5)

The optical component according to Supplementary note 3, in which the holder is joined to the snout in such a manner that the first central axis of the lens is separated from the optical axis.

### (Supplementary Note 6)

A lens holding structure including: a snout provided with a window through which light emitted from a light source passes and provided on a light emission side of a package accommodating the light source; and an optical component attached to the snout, in which the optical component includes: a lens having a first central axis along a first direction on which the light passing through the window of the snout is incident; and a holder having a second central axis along the first direction, having a principal surface perpendicular to the first direction, and on which the lens is mounted in such a manner that the first central axis is eccentric from the second central axis.

### (Supplementary Note 7)

An optical communication module including: a light source configured to emit light; a package including the light source and an optical system for guiding the light emitted from the light source, the light being emitted from an end of the package; a snout provided with a window through which the light emitted from the light source passes and provided on a light emission side of the package; and an optical component provided to the snout, in which the optical component includes: a lens having a first central axis along a first direction on which the light passing through the window of the snout is incident; and a holder having a second central axis along the first direction, having a principal surface perpendicular to the first direction, and on which the lens is mounted in such a manner that the first central axis is eccentric from the second central axis.

What is claimed is:

1. An optical component comprising:
a lens having a first central axis along a first direction; and
a holder having a second central axis along the first direction, having a principal surface perpendicular to the first direction, and on which the lens is mounted in such a manner that the first central axis is eccentric from the second central axis.

2. The optical component according to claim 1, wherein
the holder is provided with a window through which light emitted from a light source passes, and is attached to a snout provided on a light emission side of a package accommodating the light source, and
the light passing through the window is incident on the lens.

3. The optical component according to claim 2, wherein, when an optical axis of the light deviates from a third central axis of the window, the holder is joined to the snout in such a manner that a thin portion between an outer edge of the holder and the lens is arranged in a direction in which the optical axis deviates from the third central axis.

4. The optical component according to claim 3, wherein the holder is joined to the snout in such a manner that the first central axis of the lens is aligned with the optical axis.

5. The optical component according to claim 3, wherein the holder is joined to the snout in such a manner that the first central axis of the lens is separated from the optical axis.

6. A lens holding structure comprising:
a snout provided with a window through which light emitted from a light source passes and provided on a light emission side of a package accommodating the light source; and
an optical component attached to the snout, wherein
the optical component comprises:
a lens having a first central axis along a first direction on which the light passing through the window of the snout is incident; and
a holder having a second central axis along the first direction, having a principal surface perpendicular to the first direction, and on which the lens is mounted in such a manner that the first central axis is eccentric from the second central axis.

7. An optical communication module comprising:
a light source configured to emit light;
a package including the light source and an optical system for guiding the light emitted from the light source, the light being emitted from an end of the package;
a snout provided with a window through which the light emitted from the light source passes and provided on a light emission side of the package; and
an optical component provided to the snout, wherein
the optical component comprises:
a lens having a first central axis along a first direction on which the light passing through the window of the snout is incident; and
a holder having a second central axis along the first direction, having a principal surface perpendicular to the first direction, and on which the lens is mounted in such a manner that the first central axis is eccentric from the second central axis.
